(19) United States
(12) Patent Application Publication
(10) Pub. No.: US 2014/0360971 A1
(43) Pub. Date: Dec. 11, 2014

(54) Pressure-Indicating Reusable Stopper for Sparkling Beverages

(71) Applicant: Paul Anthony Marino, Meredith, NH (US)

(72) Inventor: Paul Anthony Marino, Meredith, NH (US)

(21) Appl. No.: 13/912,711

(22) Filed: Jun. 7, 2013

(51) Int. Cl. B65D 79/00; B65D 81/20; G01L 7/02

(52) U.S. Cl. CPC B65D 79/005; G01L 7/022; G01L 7/024; B65D 81/2038
USPC 215/260

(57) ABSTRACT

A pressure-indicating reusable stopper for sparkling beverages includes a pressure gauge so that when the stopper is engaged to a bottle containing some sparkling beverage, the pressure gauge indicates the pressure within the bottle on the stopper's horizontal top face to indicate whether the beverage is fresh or flat.

### FIELD OF THE INVENTION

The present invention is related to stoppers for retaining a beverage within a bottle. More specifically, the invention is related to the reusable such stoppers capable of retention against the pressure within bottles holding pressurized beverages, such as Champagnes and other sparkling wines. Even more specifically, the invention is related to such stoppers including means for indication of that pressure.

### BACKGROUND

A problem common to pressurized beverages, such as Champagne and other sparkling wines, is that once the bottle has been uncorked, the beverage will start to lose its effervescence and eventually go “flat”. The degree to which such a beverage has flattened is proportional to the quality of the wine and of the wine-drinking experience.

While this is not an issue in cases where a bottle is uncorked and then immediately fully served, purveyors of wines by the glass and salesmen wishing to offer occasional samples for a previously uncorked bottle need a way to preserve whatever gas remains in the wine and to know how much of that gas remains. Because there is no hard line between a sparkling wine that is just effervescent enough to be served as first quality and one that is not, purveyors and salesman struggle to decide when a sparkling wine is no longer servable.

Ordinary wine bottle stoppers are incapable of maintaining a sealing engagement with a bottle of sparkling wine due to the pressure within the bottle caused by the gases within the wine. That pressure tends to push the stopper out of engagement. Reusable stoppers intending to maintain engagement with such pressurized bottles and to retain the remaining pressure in such bottles are known. A common such stopper is exemplified by U.S. Pat. No. 4,175,668, generically referred to as a “clamshell” stopper, which includes a hinged pair of straps for being selectively swung down to grasp the neck of a Champagne bottle and hold the stopper in position against the pressure within the bottle. Many bartenders employ such a clamshell stopper to reseal opened bottles of sparkling wines served by the glass and many salesmen employ such stoppers to reseal opened bottles of sparkling wine poured as samples to potential customers.

A loss of pressure within the bottle reflects a proportional loss of the gas in the wine and a decay of the wine's quality and freshness. A disadvantage of such a clamshell stopper is that it can sometimes be improperly affixed, allowing the gas to escape and the wine to go flat. This improper engagement may be undetectable with such stoppers. But whether the loss of pressure is the result of a such an improper seal or by the slower natural depressurization of the wine even when the stopper is properly affixed, it still goes undetected. While the pourer may sometimes be able to recognize as the wine is poured that it has become flatter to some degree than is desirable, it may then be too late. It would be preferential to know at a glance that the wine in the bottle had reached an unacceptable level of flatness before the stopper is removed than to have the customer know that the establishment is pouring “old” wine. If the bartender knew at a glance that the wine had lost too much of its effervescence, he could simply open a new bottle instead, and prevent the embarrassment, lost time, and reputational damage of serving flat wine. And if the bartender knew at a glance that the wine was losing its effervescence, he could “push” that wine to try to ensure that it was served before it got too flat.

Attempts have been made to monitor the pressure within a bottle of sparkling wine during wine-making, such as by the device shown in U.S. Pat. No. 4,515,019. But such a device is merely a safety device intended for and only practical for use within the wine-making process as a temporary monitor against over-pressurization. Such a device is not practically reusable and cannot be made economically enough to serve as a reusable device within the intent of the present invention and as such is has had no apparent commercial success.

One of the numerous limitations of the U.S. Pat. No. 4,515,019 device is that engagement of the cap to a bottle neck is maintained by a metal tie wire. Since the tie wire will be deformed by application and removal, it may only be removed and re-attached a very limited number of times, so even if this device was sold as “reusable”, in real world use it is likely that the cost of the device amortized over the number of uses will typically exceed the cost of the wine it intended to save. It would likely be more economical to just dispose of the remaining wine rather than recap it with such a device.

Another disadvantage of the device of U.S. Pat. No. 4,515,019 lies in the height that such a device adds to a wine bottle. This is not a concern during the wine-making processes for which it was intended, but retards its use by purveyors and salesmen who cannot afford to surrender valuable storage space. Most wine bottles are of a standard height and most refrigerator shelves are spaced to accept wine bottles of that height. In most taverns, cold wines are kept in low profile under-counter “low boy” refrigerators below the bar. The '019 device, or any alternative using a pressure gauge of that general type, would add inches to the bottle's height, requiring that the bottle would either need to be stored horizontally in the refrigerator or else the shelves would need to be inefficiently spaced further apart to accommodate just that bottle. And a bottle bearing such a device could never stand up in a “low boy” refrigerator. Also, wine bottles being chilled in ice buckets are typically up-standing and more conveniently viewed from above.

An additional disadvantage to the device of U.S. Pat. No. 4,515,019 is that the pressure gauge is forward-facing. As mentioned, most taverns keep open bottles of cold wine in “low boy” refrigerators under the bar. The bartender looks downwardly at the bottles as he is selecting from them. A forward-facing dial would require him to crouch down to view it. Anyone who has been witness to the hectic pace and repetition of a bartender in a busy establishment can appreciate how impractical would be such an arrangement.

Wine salesmen typically transport their sample bottles in a typical “Sales Rep Bag”, which is a wheeled travelling cooler with upright slots for the bottles and a top-opening lid. These bags are sized to accommodate standard wine bottles. The salesman opens the lid and looks down at the top of the bottles. The '019 device is not practical for two reasons; it is too tall to fit within the bag, and its dial would not be easily viewable from above as the bag is opened.

The Champagne Pressure Gauge of U.S. Pat. No. 5,271,278 is also intended for and only practical for use during wine-making. A critical and oft-boasted aspect of this device is that the pressure gauge is inside the bottle. But since most sparkling wine bottles are darkly colored and near opaque to prevent damaging light penetration, one must presumably use a light source, such as a flashlight, to illuminate the internal pressure gauge sufficiently to read it. This may be practical in a wine-making facility, but it is not practical for purveyors or salesmen to be shining a flashlight into each wine bottle to determine whether the wine in it has gone flat. This device further lacks integral means for retaining sealing engagement of the gauge against the pressure of the wine, requiring that the gauge be held in place by a crimped-on crown cap.

Accordingly, disadvantages and flaws common to prior art wine bottle stoppers and pressure-measuring devices lie in their lack of adaptability to real-world use in a retail or wholesale environment and the inability to function as a reliable and inexpensive cap that may be used and reused continually and economically on bottle after bottle over an indeterminate length of time, Further disadvantages and flaws will be readily appreciated by those familiar with the art. There exists a need to overcome these disadvantages and flaws and such is an object of the present invention. Further needs and objects exist which are addressed by the present invention, as may become apparent by the included disclosure of an exemplary embodiment thereof.

### SUMMARY OF THE INVENTION

The invention may be practiced with or embodied by a stopper for use with a bottle having a circular shoulder below and surrounding a circular orifice communicating with a hollow interior. The stopper may include a vertically cylindrical body having a circular top and a circular bottom, an arm hingedly affixed to the cylindrical body, a circular seal disposed adjacent the circular bottom and vertically movable within and relative to the body, a pressure gauge retained by or integral with the body and disposed adjacent the circular top, and a spring downwardly biasing the circular seal relative to the pressure gauge and cylindrical body.

The pressure gauge may have a pressure sensor disposed in a bottom face and a horizontally disposed top face, wherein the arm is pivotable relative to the body between an open position and a closed position. When the stopper is disposed such that the circular seal rests on the circular orifice and the arm is in the open position, the arm does not engage the shoulder and the stopper is removable from the bottle. When the stopper is disposed such that the circular seal rests on the circular orifice, the spring is compressed, and the arm is moved into the closed position, the arm engages the shoulder and retains the circular seal against the circular orifice and the stopper is not removable from the bottle, the pressure sensor communicates with the hollow interior, and the horizontally disposed top face indicates a pressure within the hollow interior.

The circular seal may be of an elastomeric material, and may have a through-hole allowing pressure equalization from the hollow interior to the pressure sensor when the stopper engages the bottle.

The arm may be a pair of arms opposingly hingedly affixed to the cylindrical body and each adapted in its closed position to engage an opposite side of the circular shoulder. The opposing arms may be identical to each other and opposingly hingedly affixed to the cylindrical body at a common hinge axis by a pair of coaxial rivets.

The pressure gauge may be rigidly affixed by and within the cylindrical body and may include a pressure-indicating dial on its horizontally disposed circular top face. The pressure-indicating dial may include a transparent top lens, a dial face below and viewable through the transparent top lens, and a pointer disposed above the dial face, below and viewable through the transparent top lens, and rotatable to point at different markings on the dial face according to the pressure within the hollow interior. The different markings may indicate a two tiered quality indication.

The invention may also be practiced with or embodied by such a stopper wherein the pressure gauge is retained by and vertically movable within and relative to the body, and the spring downwardly biases the pressure gauge and the circular seal relative to the cylindrical body.

Further features and aspects of the invention are disclosed with more specificity in the Detailed Description and Drawings of an exemplary embodiment provided herein.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of a pressure-indicating reusable stopper for sparkling beverages according to an exemplary embodiment, engaging a bottle;

FIG. 2 is a front plan view of the stopper of FIG. 1 in its closed position;

FIG. 3 is a top view of the stopper of FIG. 1 in its closed position;

FIG. 4 is a side plan view of the stopper of FIG. 1 in its closed position;

FIG. 5 is a side cross-section through the stopper of FIG. 1 in its closed position;

FIG. 6 is a side view of the stopper of FIG. 1 in its open position being applied to the bottle;

FIG. 7 is a side view of the stopper of FIG. 1 in its closed position engaging the bottle;

FIG. 8 is a side cross-section through the stopper of FIG. 1 in its open position being applied to the bottle; and

FIG. 9 is a side cross-section through the stopper of FIG. 1 in its closed position engaging the bottle.

### DETAILED DESCRIPTION

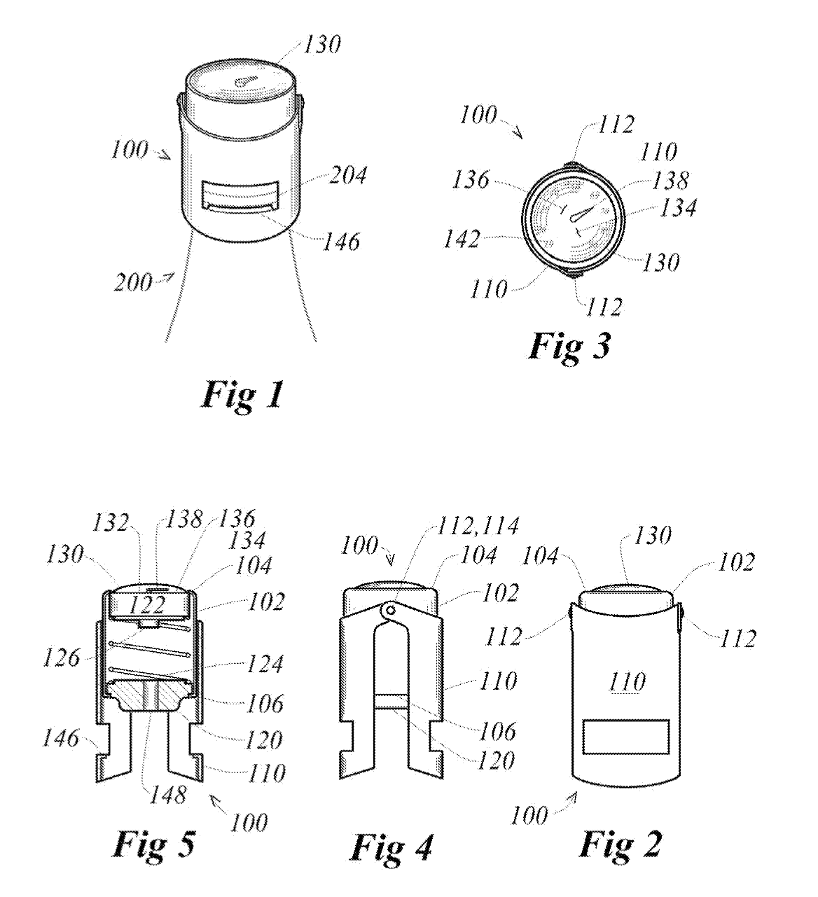

FIGS. 1 through 5 show an exemplary pressure-indicating reusable stopper for sparkling beverages according to just one of the infinite number of possible embodiments of the present invention, affixed to a typical Champagne bottle. Stopper 100 include a vertically cylindrical hollow body 102 having a circular 104 top and a circular bottom 106. A pair of identical opposing arms 110 are hingedly affixed to the cylindrical body by rivets 112 which pass through clearance holes 114 in the arms and are affixed to the body. The rivets are coaxial to provide a common hinge axis to both arms.

A circular elastomeric ring seal 120, is disposed within the body adjacent the circular bottom and vertically movable within the body. A compact circular disc-shaped pressure gauge 122 is rigidly retained by and within the body adjacent the circular top, or may be integral with the body. A compression spring 124 disposed within the body and between the pressure gauge and circular ring seal downwardly biases the seal relative to the body and pressure gauge. Less preferably, the pressure gauge and seal could both me vertically movable and disposed below the spring and the spring could bias them both together relative to the body.

The pressure gauge has a pressure sensor 126 disposed on its bottom face 128 which communicates with a pressure-indicating dial 130 horizontally disposed at its circular top face 132. The pressure indicating dial includes a dial face 134, a transparent lens, 136, and a pointer 138 which rotates to point at different markings 142 on the dial face according to the pressure sensed at the sensor. Alternatively, the pressure sensing and/or indication could be electronic and the dial could include an LCD display. Also alternatively, the dial face or LCD display could simply give a two or three tiered quality indication, such as “Good/Bad”. “Fresh/Good/Flat”, or “High/Medium/Low”.

Many applicable compact means for mechanically converting the pressure sensed at the sensor to the indication on the dial face are known and available for use within the spirit of the invention, such as that taught in U.S. Pat. No. 3,952,598, the teachings of which are incorporated herein in their entirety by reference. The pressure gauge could even be of a capacitance type, such as that taught by U.S. Pat. No. 4,935,841, the teachings of which are also incorporated herein in their entirety by reference. The invention is not limited to any particular pressure gauge type, provided it may be economically packaged within a disc-shaped housing having a diameter no larger than the circular top of the body and shallow enough to enable the seal and spring to fit and cooperate within the body.

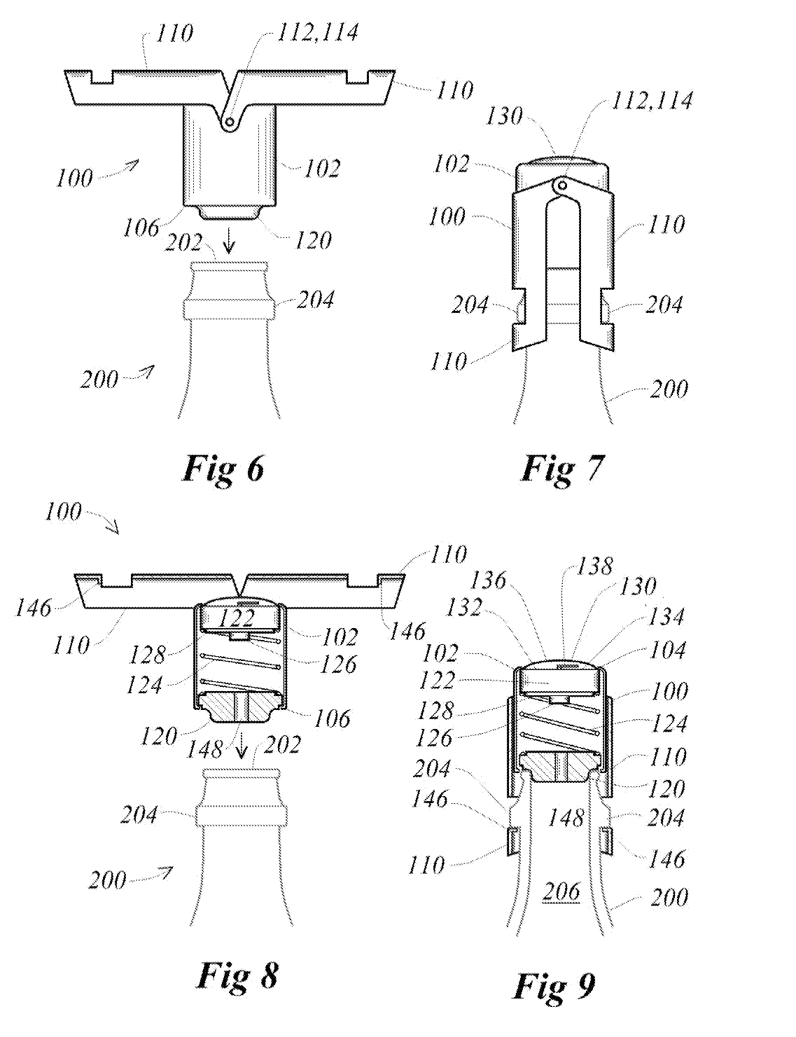

Referring now to FIGS. 6 though 9, use of the stopper 100 with a typical Champagne bottle 200 is shown. The arms are pivotable relative to the body between the open position shown in FIGS. 6 and 8 and the closed position shown in FIGS. 7 and 9.

When the stopper is disposed such that the circular ring seal rests on the bottle's circular top orifice 202, and the arms are in the open position so that the inwardly directed flanges 146 of the arms do not engage the bottle's circular shoulder 204, the stopper simply rests atop and is removable from the bottle by merely lifting. Pressure within the bottle caused by any gases therein prevent the seal from sealing the orifice and as such, the pressure gauge will show no reading.

When the stopper is disposed such that the circular seal rests on the circular orifice, the body is forced downwardly to slightly compress the spring and force the seal against the circular orifice, and then the arms are moved down into the closed position so that the inwardly directed flanges 146 of the arms engage the bottle's circular shoulder 204, the arm retain the circular seal firmly against the circular orifice and the stopper is not removable from the bottle. Pressure within the bottle equalizes with that within the stopper through hole 148 of the circular ring seal and is realized at the pressure sensor 126. The pressure sensor communicates this pressure to the pressure-indicating dial 130, which indicates the pressure within the bottle's hollow interior 206 on the dial's top face.

The pressure of wine remaining in the bottle may be instantly and conveniently viewed from above and without the need to peer or shine a flashlight into the bottle. And if the stopper is improperly seated and gas is allowed to inadvertently leak, the gauge will allow quick recognition so that the user may reapply it before the wine goes flat. The stopper is simply removed for pouring wine from the bottle or for infinite re-use by lifting the arms back to their open position.

The stopper is inexpensive to manufacture and employs an engagement mechanism of known reliability with which bartenders are already familiar and deft, When amortized over the huge number of bottles of wine on which the would likely be used through its lifetime, it is an economic insignificance. It adds no height to bottles above that already realized by ordinary clamshell stoppers which providing the benefit of pressure indication at a glance.

It should be understood that the invention is not limited to the precise embodiment described above, and that various changes and modifications thereof may be effected by one skilled in the art without departing from the spirit or scope of the invention. The invention should therefore only be limited according to the following claims, including all equivalent interpretation to which they are entitled.

I claim:

1. A stopper for use with a bottle having a circular shoulder below and surrounding a circular orifice communicating with a hollow interior, the stopper comprising:
a vertically cylindrical body having a circular top and a circular bottom;
an arm hingedly affixed to the cylindrical body;
a circular seal disposed adjacent the circular bottom and vertically movable within and relative to the body;
a pressure gauge retained by or integral with the body and disposed adjacent the circular top, the pressure gauge having a pressure sensor disposed in a bottom face and a horizontally disposed top face; and
a spring downwardly biasing the circular seal relative to the pressure gauge and cylindrical body;
wherein the arm is pivotable relative to the body between an open position and a closed position;
wherein when the stopper is disposed such that the circular seal rests on the circular orifice and the arm is in the open position, the arm does not engage the shoulder and the stopper is removable from the bottle; and
wherein when the stopper is disposed such that the circular seal rests on the circular orifice, the spring is compressed, and the arm is moved into the closed position, the arm engages the shoulder and retains the circular seal against the circular orifice and the stopper is not removable from the bottle, the pressure sensor communicates with the hollow interior, and the horizontally disposed top face indicates a pressure within the hollow interior.

2. The stopper of claim 1 wherein the circular seal is comprised of an elastomeric material.

3. The stopper of claim 2 wherein the circular seal comprises a through-hole allowing pressure equalization from the hollow interior to the pressure sensor when the stopper is disposed such that the circular seal rests on the circular orifice, the spring is compressed, and the arm is moved into the closed position, and the arm engages the circular shoulder and retains the circular seal against the circular orifice.

4. The stopper of claim 1 wherein the circular seal comprises a through-hole allowing pressure equalization from the hollow interior to the pressure sensor when the stopper is disposed such that the circular seal rests on the circular orifice, the spring is compressed, and the arm is moved into the closed position, and the arm engages the circular shoulder and retains the circular seal against the circular orifice.

5. The stopper of claim 1 wherein the arm is a pair of arms opposingly hingedly affixed to the cylindrical body and each adapted in its closed position to engage an opposite side of the circular shoulder.

6. The stopper of claim 5 wherein the opposing arms are identical to each other.

7. The stopper of claim 6 wherein the arms are opposingly hingedly affixed to the cylindrical body at a common hinge axis by a pair of coaxial rivets.

8. The stopper of claim 1 wherein the pressure gauge is rigidly affixed by and within the cylindrical body.

9. The stopper of claim 8 wherein the pressure gauge comprises a pressure-indicating dial on its horizontally disposed circular top face, the pressure-indicating dial comprising a transparent top lens, a dial face below and viewable through the transparent top lens, and a pointer disposed above the dial face, below and viewable through the transparent top lens, and rotatable to point at different markings on the dial face according to the pressure within the hollow interior.

10. The stopper of claim 9 wherein the different markings indicate a two tiered quality indication.

11. A stopper for use with a bottle having a circular shoulder below and surrounding a circular orifice communicating with a hollow interior, the stopper comprising:
a vertically cylindrical body having a circular top and a circular bottom;
an arm hingedly affixed to the cylindrical body;
a circular seal disposed adjacent the circular bottom and vertically movable within and relative to the body;
a pressure gauge retained by and vertically movable within and relative to the body, the pressure gauge having a pressure sensor disposed in a bottom face and a horizontally disposed top face; and
a spring downwardly biasing the pressure gauge and the circular seal relative to the cylindrical body;
wherein the arm is pivotable relative to the body between an open position and a closed position;
wherein when the stopper is disposed such that the circular seal rests on the circular orifice and the arm is in the open position, the arm does not engage the shoulder and the stopper is removable from the bottle; and
wherein when the stopper is disposed such that the circular seal rests on the circular orifice, the spring is compressed, and the arm is moved into the closed position, the arm engages the circular shoulder and retains the circular seal against the circular orifice and the stopper is not removable from the bottle, the pressure sensor communicates with the hollow interior, and the horizontally disposed top face indicates a pressure within the hollow interior.

12. The stopper of claim 11 wherein the circular seal is comprised of an elastomeric material.

13. The stopper of claim 12 wherein the circular seal comprises a through-hole allowing pressure equalization from the hollow interior to the pressure sensor when the stopper is disposed such that the circular seal rests on the circular orifice, the spring is compressed, and the arm is moved into the closed position, and the arm engages the circular shoulder and retains the circular seal against the circular orifice.

14. The stopper of claim 11 wherein the circular seal comprises a through-hole allowing pressure equalization from the hollow interior to the pressure sensor when the stopper is disposed such that the circular seal rests on the circular orifice, the spring is compressed, and the arm is moved into the closed position, and the arm engages the circular shoulder and retains the circular seal against the circular orifice.

15. The stopper of claim 11 wherein the arm is a pair of arms opposingly hingedly affixed to the cylindrical body and each adapted in its closed position to engage an opposite side of the circular shoulder.

16. The stopper of claim 15 wherein the opposing arms are identical to each other.

17. The stopper of claim 16 wherein the arms are opposingly hingedly affixed to the cylindrical body at a common hinge axis by a pair of coaxial rivets.

18. The stopper of claim 11 wherein the pressure gauge is rigidly affixed by and within the cylindrical body.

19. The stopper of claim 18 wherein the pressure gauge comprises a pressure-indicating dial on its horizontally disposed circular top face, the pressure-indicating dial comprising a transparent top lens, a dial face below and viewable through the transparent top lens, and a pointer disposed above the dial face, below and viewable through the transparent top lens, and rotatable to point at different markings on the dial face according to the pressure within the hollow interior.

20. The stopper of claim 19 wherein the different markings indicate a two tiered quality indication.
